(19) United States
(12) Patent Application Publication
(10) Pub. No.: US 2024/0123467 A1
(43) Pub. Date: Apr. 18, 2024

(54) METHOD FOR COATING VEHICLE BODY

(71) Applicant: TOYOTA JIDOSHA KABUSHIKI KAISHA, Toyota-shi (JP)

(72) Inventors: Keiji AMBO, Miyoshi-shi (JP); Junya OGAWA, Okazaki-shi (JP); Hisao HAYASHI, Nagakute-shi (JP)

(73) Assignee: TOYOTA JIDOSHA KABUSHIKI KAISHA, Toyota-shi (JP)

(21) Appl. No.: 18/480,937

(22) Filed: Oct. 4, 2023

(30) Foreign Application Priority Data
Oct. 14, 2022 (JP) 2022-165644

(51) Int. Cl. B05D 7/00; B05D 7/14

(52) U.S. Cl. CPC B05D 7/572; B05D 7/14

(57) ABSTRACT

A method for coating a vehicle body on which an electrodeposition coating has been performed includes in this order: applying a first base coating material over an outer surface of the vehicle body to form a first base layer; applying a mixture of a second base coating material and a first curing agent over an inner surface of the vehicle body to form an inner second base layer; applying the second base coating material over the first base layer that has not been baked to form an outer second base layer; applying a clear coating material over the inner second base layer and the outer second base layer to form a clear layer; and baking the first base layer, the inner second base layer, the outer second base layer, and the clear layer for curing thereof.

### CROSS REFERENCE TO RELATED APPLICATIONS

The present application claims priority from Japanese patent application JP 2022-165644 filed on Oct. 14, 2022, the entire content of which is hereby incorporated by reference into this application.

### BACKGROUND

### Technical Field

The present disclosure relates to a method for coating a vehicle body.

### Background Art

JP 2015-009222 A discloses a method for coating an automobile body for providing a satisfactory appearance while reducing a CO₂ emission amount and saving energy. In this method, an outer surface of an automobile body on which electrodeposition coating is performed is coated with a first base paint without performing midcoat coating, subsequently, an inner surface of the automobile body is coated with a second base paint, subsequently, an outer surface of the automobile body is coated with the second base paint by wet-on-wet coating, subsequently, the automobile body is coated with a clear paint by wet-on-wet coating, and subsequently, the coated paints are simultaneously baked and cured. A curing temperature of the second base paint is higher than a curing temperature of the first base paint.

### SUMMARY

For further reducing the CO₂ emission amount and the energy consumption in a manufacturing process of a vehicle, it is desired to cure a coating material by baking it at a lower temperature. However, since a temperature of an inner surface of a vehicle body during the baking is usually lower than a temperature of an outer surface, applying a low baking temperature to the method disclosed in JP 2015-009222 A possibly causes insufficient curing of the second base coating material (the second base paint) coated on the inner surface of the automobile body.

Therefore, the present disclosure provides a method for coating a vehicle body capable of sufficiently curing a coating material with a baking at a low temperature.

The present disclosure includes the following aspects.

1. A method for coating a vehicle body on which an electrodeposition coating has been performed comprises in this order: applying a first base coating material over an outer surface of the vehicle body to form a first base layer; applying a mixture of a second base coating material and a first curing agent over an inner surface of the vehicle body to form an inner second base layer; applying the second base coating material over the first base layer that has not been baked to form an outer second base layer; applying a clear coating material over the inner second base layer and the outer second base layer to form a clear layer; and baking the first base layer, the inner second base layer, the outer second base layer, and the clear layer for curing thereof.
2. In the method according to the aspect 1, in the baking of the first base layer, the inner second base layer, the outer second base layer, and the clear layer, a curing temperature of the inner second base layer may be lower than a curing temperature of the outer second base layer.
3. In the method according to the aspect 1 or 2, in the baking of the first base layer, the inner second base layer, the outer second base layer, and the clear layer, a curing temperature of the inner second base layer may be lower than a curing temperature of the first base layer.
4. In the method according to any one of the aspects 1 to 3, the clear coating material may contain a second curing agent, and the second curing agent may diffuse into the inner second base layer and the outer second base layer.
5. In the method according to any one of the aspects 1 to 4, the first base coating material may contain a third curing agent, and the third curing agent may diffuse into the outer second base layer.
6. In the method according to any one of the aspects 1 to 5, the inner second base layer may include a portion not covered with the clear layer.
7. In the method according to any one of the aspects 1 to 6, in the applying of the second base coating material over the first base layer, the first base layer may have not undergone a preheating.

The method of the present disclosure allows sufficient curing of the coating material with the baking at low temperature.

### BRIEF DESCRIPTION OF THE DRAWINGS

FIG. 1 is a flowchart illustrating a method according to an embodiment; and

FIG. 2 is a schematic cross-sectional view of a vehicle body coated by the method according to the embodiment.

### DETAILED DESCRIPTION

The following describes the embodiment with reference to the drawings as necessary. In the drawings referred in the following description, the same reference numerals may be attached to the same members or the members having similar functions, and their repeated explanations may be omitted in some cases. For convenience of explanation, dimensional ratios and shapes of respective units in the drawings are exaggerated, and may differ from actual dimensional ratios and shapes in some cases.

The terms “comprise,” “include,” and “contain” herein mean that an additional component may be included, and encompass the terms “consisting essentially of” and “consisting of.” The term “consisting essentially of” means that an additional component having substantially no adverse effect may be contained. The term “consisting of” means including only the described materials, but does not exclude inclusion of inevitable impurities.

The term “on” herein includes both of “directly on” and “indirectly on” insofar as it is not especially specified in the context.

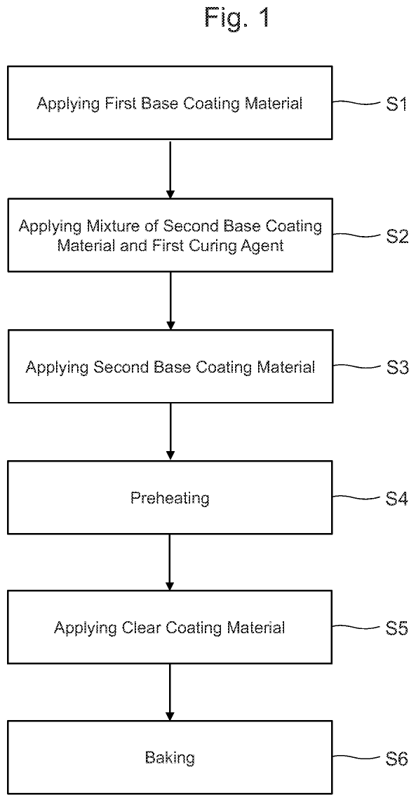

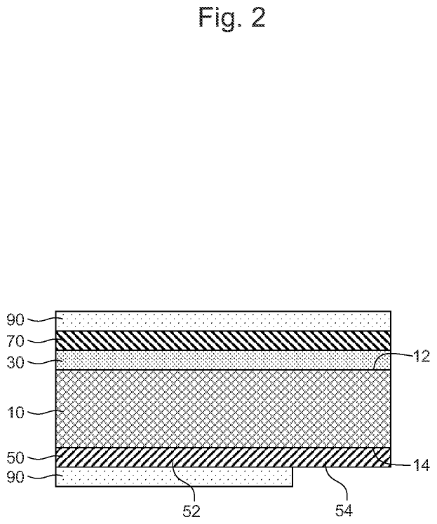

A method for coating a vehicle body on which an electrodeposition coating has been performed (a vehicle body on which an electrodeposition coating has been performed is hereinafter simply referred to as a “vehicle body”) according to the embodiment includes in this order, as illustrated in FIGS. 1 and 2, Step S1 of applying a first base coating material over an outer surface 12 of a vehicle body 10 to form a first base layer 30, Step S2 of applying a mixture of a second base coating material and a first curing agent over an inner surface 14 of the vehicle body 10 to form an inner second base layer 50, Step S3 of applying the second base coating material over the first base layer 30 that has not been baked to form an outer second base layer 70, Step S4 of preheating the first base layer 30, the inner second base layer 50, and the outer second base layer 70, Step S5 of applying a clear coating material over the inner second base layer 50 and the outer second base layer 70 to form a clear layer 90, and Step S6 of baking the first base layer 30, the inner second base layer 50, the outer second base layer 70, and the clear layer 90 for curing thereof. The preheating step S4 is not an essential step, but an optional step. FIG. 2 is a schematic cross-sectional view of the vehicle body coated by the method according to the embodiment.

### (1) Step S1 of Applying First Base Coating Material

First, the vehicle body 10 is prepared. The vehicle body 10 is manufactured by, for example, an electrodeposition coating over a substrate containing a metal, such as iron. The electrodeposition coating may be any of a cation electrodeposition coating or an anion electrodeposition coating. In the manufacture of vehicle, generally, the cation electrodeposition coating is applied.

The vehicle body 10 may be a body of an automobile, a scooter, a bicycle, a cart, or the like. The automobile body can include a roof, a door, an engine hood, a bumper, or the like. The vehicle body 10 has an outer surface 12 facing an external environment when assembled to the vehicle, and an inner surface 14 as an opposite surface of the outer surface 12.

The first base coating material is applied over the outer surface 12 of the vehicle body 10, thereby forming the first base layer 30. The first base coating material may be applied by any method.

The first base coating material may be a water-based coating material, and for example, may be a water-based emulsion coating material. The first base coating material may contain a resin and a pigment. Examples of the resin include an acrylic resin, polyester, and polyurethane. Examples of the pigment include titanium oxide, carbon, an inorganic extender pigment, talc, aluminum, an organic coloring pigment, and mica. Examples of the inorganic extender pigment include barium sulfate, calcium carbonate, and kaolin. The first base coating material may further contain a curing agent (hereinafter referred to as a “third curing agent”). Examples of the third curing agent include isocyanate and carbodiimide. The third curing agent can diffuse into the outer second base layer 70 formed by Step S3 described later. The first base coating material may further contain an additive as necessary.

The first base layer 30 is not baked in the process up to Step S3 described later, and even not preheated in some embodiments. The baking herein means heating a layer under a condition that a coating material constituting the layer cures. The preheating means drying a layer by an active heating under a condition that a coating material constituting the layer does not cure. Natural drying is not included in the preheating.

### (2) Step S2 of Applying Mixture of Second Base Coating Material and First Curing Agent

Next, a mixture of the second base coating material and the first curing agent (hereinafter referred to as a “second base mixture” as necessary) is applied over the inner surface 14 of the vehicle body 10, thereby forming the inner second base layer 50. The second base mixture may be applied by any method.

The second base coating material plays a role in expressing a color phase. The second base coating material may be a water-based coating material. The second base coating material may contain a resin and a pigment. Examples of the resin include an acrylic resin, polyester, and polyurethane. Examples of the pigment include aluminum, an organic coloring pigment, titanium oxide, carbon, and mica. The second base coating material may further contain an additive as necessary.

Examples of the first curing agent include isocyanate and carbodiimide. The second base mixture has a curing temperature lower than a curing temperature of the second base coating material because of the action of the first curing agent. The second base mixture may have the curing temperature lower than a curing temperature of the first base coating material. The “curing temperature” of the coating material or the mixture herein means a temperature when reduction of a viscosity of the coating material or the mixture stops and turns to increase during the temperature rise of the coating material or the mixture. The viscosity of the coating material or the mixture during the temperature rise is measured by a dynamic viscoelasticity measuring device.

Mixing the second base coating material and the first curing agent may be performed by any method. For example, mixing and applying of the second base coating material and the first curing agent can be performed using a bell type coating device. In the bell type coating device, supply lines of the second base coating material and the first curing agent may be joined at a bell cup or at a proximity thereof.

### (3) Step S3 of Applying Second Base Coating Material

Subsequently, the second base coating material is applied over the first base layer 30 formed on the outer surface 12 of the vehicle body 10, thereby forming the outer second base layer 70. At this time, as described above, the first base layer 30 has not undergone the baking, and has not undergone the preheating in some embodiments. Accordingly, the CO₂ emission amount and the energy consumption in the coating process are reduced. The second base coating material may be applied by any method.

Since the second base coating material used in Step S3 is similar to the second base coating material used in Step S2, the detailed description will be omitted. The second base coating material may have the curing temperature higher than the curing temperature of the first base coating material.

### (4) Preheating Step S4

Next, the first base layer 30, the inner second base layer 50, and the outer second base layer 70 may be preheated. The conditions of the temperature, the period, and the like for the preheating are appropriately set depending on the types, the amounts, and the like of the first base coating material, the second base coating material, and the first curing agent to be used.

### (5) Step S5 of Applying Clear Coating Material

Next, the clear coating material is applied over the inner second base layer 50 and the outer second base layer 70, thereby forming the clear layer 90. The clear coating material may be applied by any method. The whole of the outer second base layer 70 may be coated with the clear layer 90. The inner second base layer 50 may include a covered portion 52 covered with the clear layer 90 and a non-covered portion 54 exposed without being covered with the clear layer 90.

The clear coating material may be a water-based or oil-based coating material. The clear coating material may contain a resin and a pigment. Examples of the resin include an acrylic resin, polyester, and polyurethane. The clear coating material may further contain a curing agent (hereinafter referred to as a “second curing agent”). Examples of the second curing agent include isocyanate. The second curing agent can diffuse into the inner second base layer 50 and the outer second base layer 70. The clear coating material may further contain an additive, a curing catalyst, or the like as necessary. The clear coating material may have a curing temperature higher than the curing temperature of the second base mixture used in Step S2. The clear coating material may have the curing temperature higher than the curing temperature of the second base coating material.

### (6) Baking Step S6

Subsequently, the first base layer 30, the inner second base layer 50, the outer second base layer 70, and the clear layer 90 are baked to be cured. The baking can be performed by any heating method, for example, hot-air heating, infrared heating, and high-frequency heating. The conditions of the temperature, the period, and the like for the baking are appropriately set depending on the types, the amounts, and the like of the first base coating material, the second base coating material, the first curing agent, and the clear coating material to be used.

The curing temperature of the outer second base layer 70 may be higher than the curing temperature of the first base layer 30 and lower than the curing temperature of the clear layer 90. This allows the first base layer 30, the outer second base layer 70, and the clear layer 90 to be cured in this order on the outer surface 12 of the vehicle body 10. As a result, these layers after the curing can be provided with high smoothness, thus providing a high quality of external appearance. The outer second base layer 70 can contain the third curing agent supplied from the first base layer 30 and/or the second curing agent supplied from the clear layer 90. This allows the outer second base layer 70 to have the curing temperature lower than the curing temperature of the second base coating material.

The curing temperature of the inner second base layer 50 may be lower than the curing temperature of the clear layer 90. This allows the inner second base layer 50 and the clear layer 90 to be cured in this order on the inner surface 14 of the vehicle body 10. As a result, these layers after the curing can be provided with high smoothness, thus providing a high quality of external appearance. The covered portion 52 of the inner second base layer 50 can contain the second curing agent supplied from the clear layer 90, and this allows the covered portion 52 of the inner second base layer 50 to have the curing temperature lower than the curing temperature of the second base mixture. Meanwhile, since the non-covered portion 54 of the inner second base layer 50 is not supplied with the curing agents from the other layers, the non-covered portion 54 of the inner second base layer 50 can have the curing temperature similar to the curing temperature of the second base mixture.

The curing temperature of the inner second base layer 50 may be lower than the curing temperature of the outer second base layer 70. The temperature of the inner surface 14 of the vehicle body 10 during the baking is usually lower than the temperature of the outer surface 12. Considering this, in the related art in which the curing temperature of the inner second base layer 50 is the same as the curing temperature of the outer second base layer 70, it is required that the preset temperature of the baking should be significantly higher than the curing temperature of the outer second base layer. This is because otherwise the curing of the inner second base layer 50 becomes insufficient. However, in this embodiment in which the curing temperature of the inner second base layer 50 is lower than the curing temperature of the outer second base layer 70, even when the preset temperature of the baking is lower than the related art, the inner second base layer 50 can be sufficiently cured.

The curing temperature of the inner second base layer 50 may be lower than the curing temperature of the first base layer 30. This allows the inner second base layer 50 to be sufficiently cured while the preset temperature of the baking is further lowered.

In this application, the differences between the curing temperatures of the respective layers can be compared by using the curing temperature of the first base coating material as the curing temperature of the first base layer 30, using the curing temperature of the second base mixture as the curing temperature of the inner second base layer 50, using the curing temperature of the second base coating material as the curing temperature of the outer second base layer 70, and using the curing temperature of the clear coating material as the curing temperature of the clear layer 90.

The coating method according to the above-described embodiment can be performed by using, for example, a facility that includes a zone of applying a first base coating material over an outer surface 12 of a vehicle body 10 to form a first base layer 30, a zone of applying a second base mixture over an inner surface 14 of the vehicle body 10 to form an inner second base layer 50, a zone of applying the second base coating material over the first base layer 30 that has not been baked to form an outer second base layer 70, a zone of preheating the first base layer 30, the inner second base layer 50, and the outer second base layer 70, a zone of applying a clear coating material over the inner second base layer 50 and the outer second base layer 70 to form a clear layer 90, and a zone of baking the first base layer 30, the inner second base layer 50, the outer second base layer 70, and the clear layer 90 for curing thereof, which are provided in this order along a conveying direction of the vehicle body 10. The vehicle body 10 may be sequentially conveyed to each of the zones.

In the above-described facility, applying the coating material and the mixture may be performed using a robot, or may be performed manually. In each of the zones, the door, the hood, and the like may be opened and closed as necessary. The door may be opened and closed by using a robot, or may be opened and closed manually.

In the above-described facility, between the respective zones, a setting zone may be further provided. In the setting zone, the smoothness can be improved by flowing the first base layer 30, the inner second base layer 50, the outer second base layer 70, and/or the clear layer 90 formed in the zone upstream thereof. In the setting zone, the qualities of the first base layer 30, the inner second base layer 50, the outer second base layer 70, and/or the clear layer 90 formed in the zone upstream thereof may be verified.

The present disclosure is not limited to the above-described embodiment, but various kinds of changes of design are allowed within a range not departing from the spirits of the present disclosure described in the claims.

What is claimed is:

1. A method for coating a vehicle body on which an electrodeposition coating has been performed, the method comprising in this order:
applying a first base coating material over an outer surface of the vehicle body to form a first base layer;
applying a mixture of a second base coating material and a first curing agent over an inner surface of the vehicle body to form an inner second base layer;
applying the second base coating material over the first base layer that has not been baked to form an outer second base layer;
applying a clear coating material over the inner second base layer and the outer second base layer to form a clear layer; and
baking the first base layer, the inner second base layer, the outer second base layer, and the clear layer for curing thereof.

2. The method according to claim 1,
wherein in the baking of the first base layer, the inner second base layer, the outer second base layer, and the clear layer, a curing temperature of the inner second base layer is lower than a curing temperature of the outer second base layer.

3. The method according to claim 1,
wherein in the baking of the first base layer, the inner second base layer, the outer second base layer, and the clear layer, a curing temperature of the inner second base layer is lower than a curing temperature of the first base layer.

4. The method according to claim 1,
wherein the clear coating material contains a second curing agent, and
wherein the second curing agent diffuses into the inner second base layer and the outer second base layer.

5. The method according to claim 1,
wherein the first base coating material contains a third curing agent, and
wherein the third curing agent diffuses into the outer second base layer.

6. The method according to claim 1,
wherein the inner second base layer includes a portion not covered with the clear layer.

7. The method according to claim 1,
wherein in the applying of the second base coating material over the first base layer, the first base layer has not undergone a preheating.
